(19) United States
(12) Patent Application Publication
(10) Pub. No.: US 2019/0056069 A1
(43) Pub. Date: Feb. 21, 2019

(54) LAMP STRUCTURE

(71) Applicant: YU LUO, SHENZHEN (CN)

(72) Inventor: YU LUO, SHENZHEN (CN)

(21) Appl. No.: 15/678,478

(22) Filed: Aug. 16, 2017

(51) Int. Cl. F21K 9/232; F21V 23/06; F21K 9/237; F21V 29/77; F21V 17/10; F21V 1/00

(52) U.S. Cl. CPC F21K 9/232; F21V 23/06; F21K 9/237; F21Y 2115/10; F21V 17/108; F21V 1/00; F21V 29/773

(57) ABSTRACT

The present invention relates to a lamp structure, which comprises a lamp cap, a plurality of first light-emitting modules, and a second light-emitting module. The lamp cap includes a body, which includes a connecting surface. One end of each of the plurality of first light-emitting modules surrounds the periphery of the connecting surface. The second light-emitting module includes a connecting lamp base. The other end of each first light-emitting module surrounds the periphery of the connecting lamp base. In addition, the outer diameter of the connecting lamp base is smaller than the outer diameter of the connecting surface. Thereby, the lighting angle of the plurality of first light-emitting modules can supplement the lighting range of the second light-emitting module.

### FIELD OF THE INVENTION

The present invention relates generally to a lamp, and particularly to a lamp structure capable of being assembled and concentrating light for lighting.

### BACKGROUND OF THE INVENTION

The lamp is one of human's most important inventions. It provides people with tremendous convenience. As technologies advance day by day, there are various commercial lamp models with respective distinguishing features. No matter incandescent lamps, fluorescent lamps, halogen lamps, electrodeless fluorescent lamps, mercury-free fluorescent lamps, and light-emitting diode (LED) lamps, they all own specific optical, safety, environment characteristics and cost-to-performance ratios. In particular, LED lamps have strong potential advantages. Hence, their applications as well as market share will expand rapidly.

As the lighting technologies develop, the evaluation on future lighting source is not placed on the luminous efficacy only. The evaluations on the lighting effect, comfort, biological effects, safety, environment characteristics, resource consumption are stressed as well. In addition, due to their advantages of low power consumption and long lifetime, no matter public or domestic lighting, LEDs have gradually replaced general commercial incandescent and power-saving lamps. The related products of LEDs are also being developed prosperously.

According to the prior art, the light emitted by the LED chips in an LED lamp structure is directional. Thereby, other structures or devices are required to scatter the light and hence enabling the light from the LED lamp structure more uniform instead of being concentrated. Alternatively, a plurality of LED chips are adopted and disposed spanning 360 degrees in a lamp structure. Thereby, the optical path of the light emitted by the LED chips can cover the surroundings uniformly. Unfortunately, changes on the light emitted by the LED lamp structures as described above are still quite limited. Besides, the LED lamp structures according to the prior art are mostly fixed, resulting in little changes on light illumination.

The drawback of the LED lamp structures according to the prior art is their inflexible usage caused by their fixed structures. Accordingly, the present invention provides a lamp structure to solve the drawback in the prior art.

### SUMMARY

An objective of the present invention is to provide a lamp structure. The light of the lamp structure is concentrated toward a direction and supplementing the ambient light.

Another objective of the present invention is to provide a lamp structure. The partially damaged light-emitting module in the lamp structure can be repaired individually and thus reducing the maintenance cost.

A further objective of the present invention is to provide a lamp structure. The number of the light-emitting modules in the lamp structure can be changed according to users' requirements. Thereby, users' demand can be met.

The present invention provides a lamp structure, which comprises a lamp cap, a plurality of first light-emitting modules, and a second light-emitting module. The lamp cap includes a body. The body includes a plurality of connecting surfaces. One end of the plurality of first light-emitting modules surrounds the periphery of the connecting surface. The second light-emitting module includes a connecting base. The other end of the plurality of first light-emitting modules surround the periphery of the connecting base. Besides, the circumference of the connecting base is smaller than that of the connecting surface.

According to an embodiment of the present invention, the connecting surface of the lamp cap further includes a plurality of connecting parts. Each connecting part includes a first fixing part and an electrical connecting part. Each first light-emitting module includes a second fixing part and a second electrical connecting part at one end. Each first fixing part is fixed with the second fixing part. The first electrical connecting part and the second electrical connecting part are connected.

According to an embodiment of the present invention, the first fixing part is a fixing recess; the second fixing part is a fixing bump. The second fixing part is wedged into the first fixing part.

According to an embodiment of the present invention, the other end of each first light-emitting module includes a third fixing part. The connecting base includes a plurality of heat dissipating fins and a plurality of fourth fixing parts. The plurality of fourth fixing parts are disposed on the connecting base. The third fixing part and the fourth fixing part fix each other.

According to an embodiment of the present invention, the third fixing part is a hook and the fourth fixing part is a fixing pillar. The third fixing part hooks the fourth fixing part.

According to an embodiment of the present invention, each first light-emitting module further includes a first lamp base, a first lamp plate, and a first lampshade. The first lamp base includes a first lamp recess. The first lamp plate is disposed in the first lamp recess of the first lamp base. The first lampshade covers the first lamp plate and is disposed on the first lamp base.

According to an embodiment of the present invention, the first lampshade includes a plurality of buckle members on the periphery. The first lamp base includes a plurality of buckle holes corresponding to the plurality of buckle members and located on the periphery of the first lamp recess. The plurality of buckle members of the first lampshade buckle into the plurality of buckle holes in the first lamp base.

According to an embodiment of the present invention, the first light-emitting module further includes a first heat dissipating structure disposed on the side of the first lamp base opposite to the first lamp recess.

According to an embodiment of the present invention, the second light-emitting module further includes a second lamp plate and a second lampshade. The connecting lamp base includes a second lamp recess. The second lamp plate is disposed in the second lamp recess of the connecting lamp base. The second lampshade covers the second lamp plate and is disposed on the connecting lamp base.

According to an embodiment of the present invention, the second lampshade includes a plurality of buckle members on the periphery. The connecting lamp base includes a plurality of buckle holes corresponding to the plurality of buckle members and located on the periphery of the second lamp recess. The plurality of buckle members of the second lampshade buckle into the plurality of buckle holes in the connecting lamp base.

### BRIEF DESCRIPTION OF THE DRAWINGS

FIG. 1 shows a stereoscopic diagram of the lamp structure according to the present invention;

FIG. 2 shows an exploded view of the lamp structure according to the present invention;

FIG. 3 shows a detailed exploded view of the lamp structure according to the present invention;

FIG. 4 shows another detailed exploded view of the lamp structure according to the present invention; and

FIG. 5 shows a usage diagram of the lamp structure according to the present invention.

### DETAILED DESCRIPTION

In order to make the structure and characteristics as well as the effectiveness of the present invention to be further understood and recognized, the detailed description of the present invention is provided as follows along with embodiments and accompanying figures.

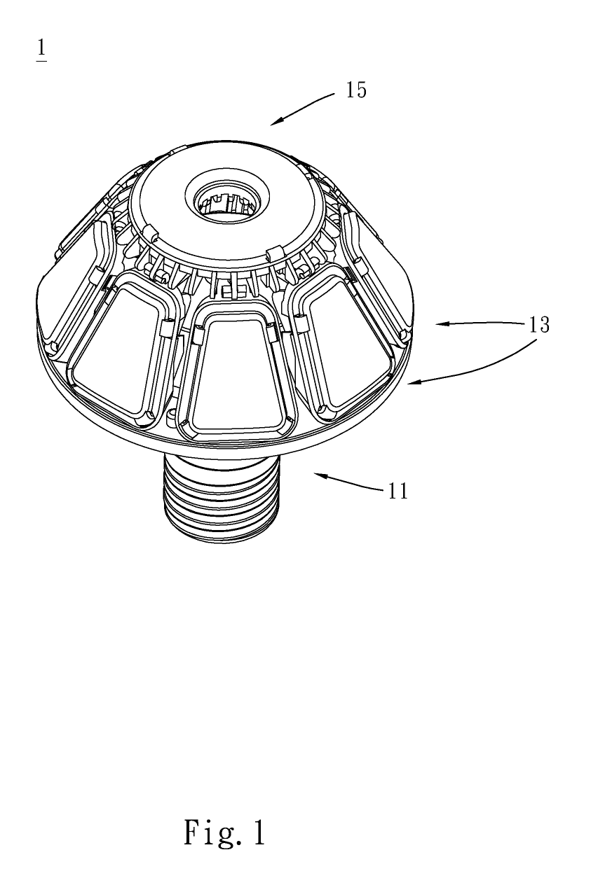

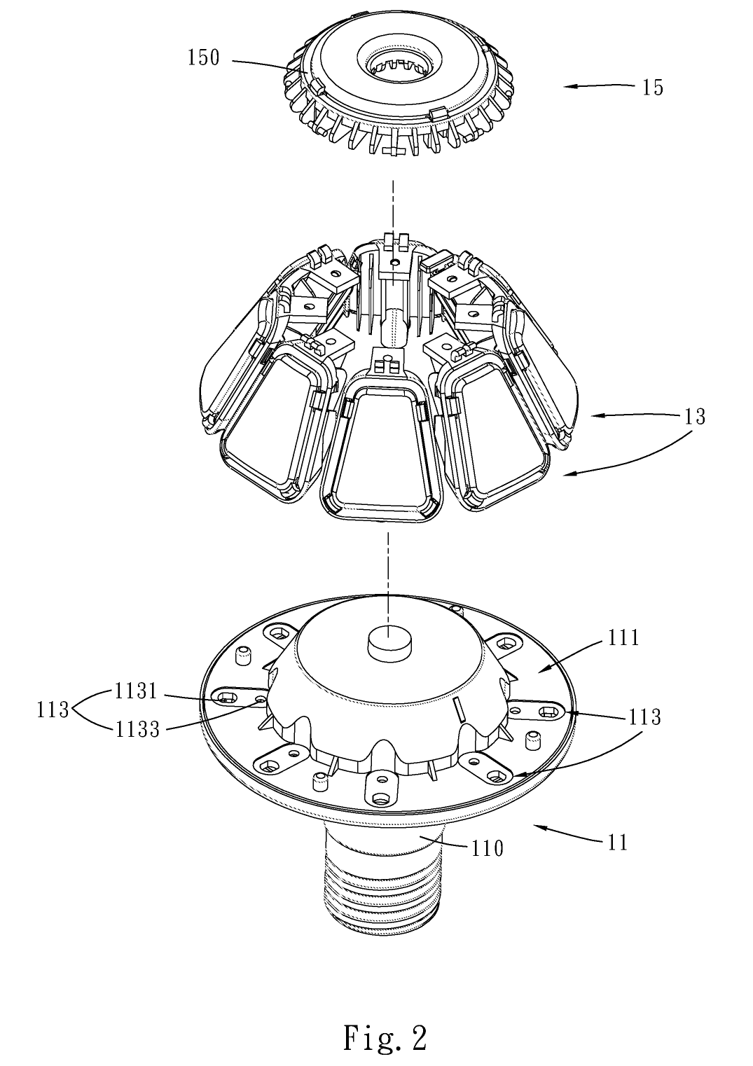

Please refer to FIG. 1 and FIG. 2, which shows a stereoscopic diagram and an exploded view of the lamp structure according to the present invention. As shown in the figures, the present embodiment provides a lamp structure 1 formed by multiple light-emitting modules. The lamp structure 1 can be assembled and disassembled with ease. According to the present embodiment, the lamp structure 1 comprises a lamp cap 11, a plurality of first light-emitting modules 13, and a second light-emitting module 15.

The lamp cap 11 includes a body 110, which includes a connecting surface 111 on the bottom surface. One end of each of the plurality of first light-emitting modules 13 surrounds the periphery of the connecting surface 111. The second light-emitting module 15 includes a connecting lamp base 150. The other end of each of the plurality of first light-emitting modules 13 surrounds the periphery of the connecting lamp base 150. In addition, the circumference of the connecting lamp base 150 is smaller than the circumference of the connecting face 111. In other words, the outer diameter of the connecting lamp base 150 is smaller than the outer diameter of the connecting surface 111. One end of each first light-emitting module 13 is located on the outer side while the other end thereof on the inner side. Thereby, the plurality of first light-emitting modules 13 are oblique. The light-emitting surfaces of the plurality of first light-emitting modules 13 are not perpendicular to the light-emitting surfaces of the second light-emitting module 15. According to the present embodiment, the light-emitting surface of the second light-emitting module 15 is planar. Contrarily, the light-emitting surface of each first light-emitting module 13 is oblique and surrounds the second light-emitting module 15.

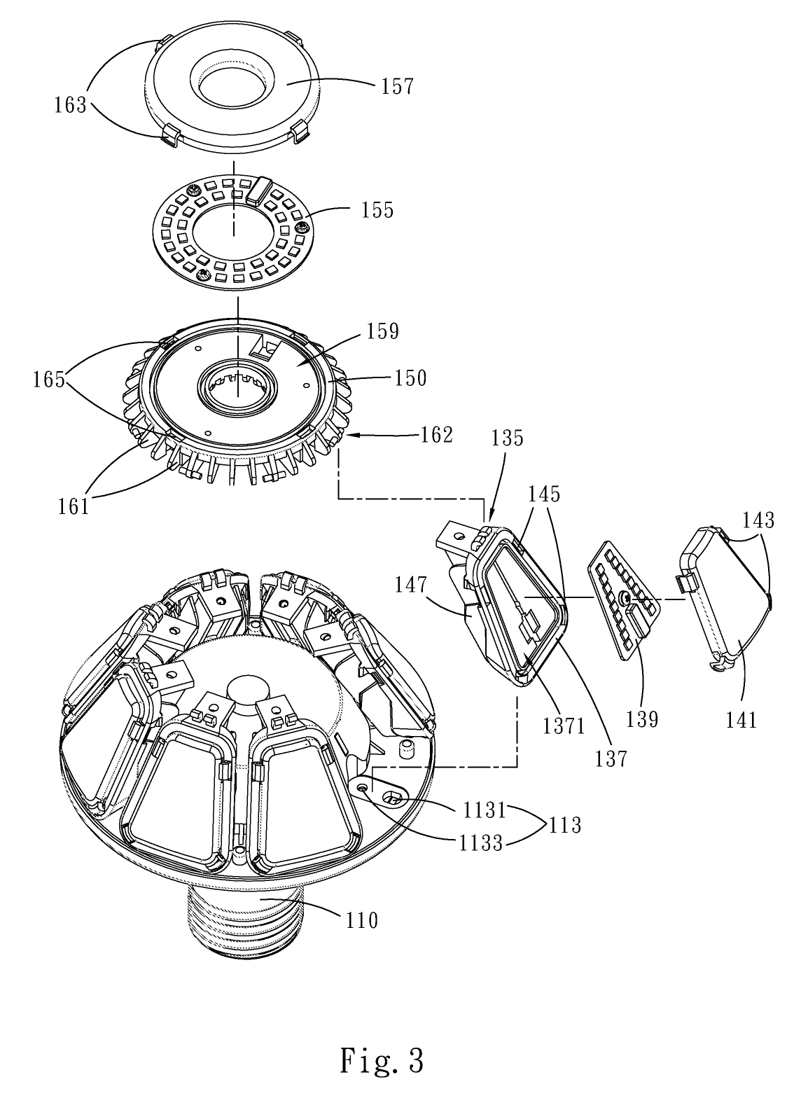

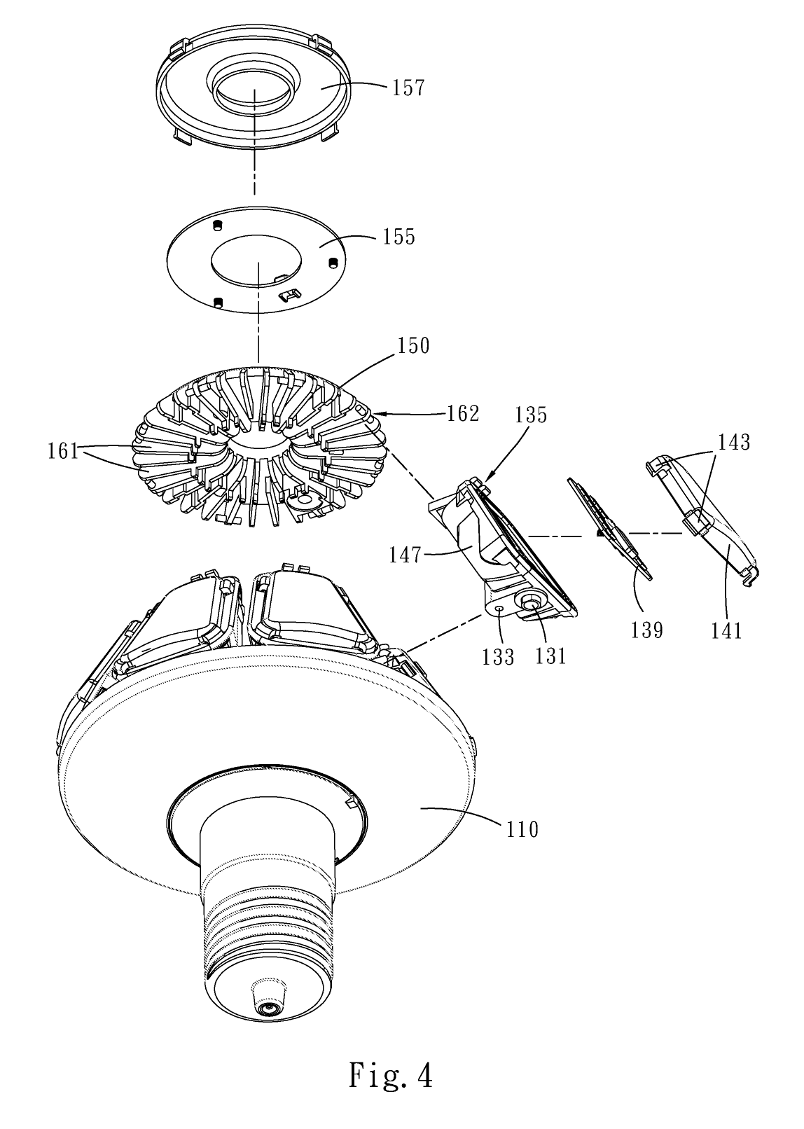

Please refer to FIG. 3 and FIG. 4, which show detailed exploded views of the lamp structure according to the present invention. As shown in the figures, according to the present embodiment, the connecting surface 111 of the lamp cap 11 includes a plurality of connecting parts 113. Each connecting part 113 includes a first fixing part 1131 and a first electrical connecting part 1133. One end of each first light-emitting module 13 includes a second fixing part 131 and a second electrical connecting part 133. The first fixing part 1131 and the second fixing part 131 fix each other. The first electrical connecting part 1133 and the second electrical connecting part 133 connect electrically with each other. Thereby, the plurality of first light-emitting modules 13 are connected electrically and fixed to the connecting surface 111 of the lamp cap 11. Besides, the first fixing part 1131 is a fixing recess; the second fixing part 131 is a fixing bump; and the second fixing part 131 is wedged into the first fixing part 1131.

Furthermore, each first light-emitting module 13 includes a third fixing part 135 at the other end. The connecting lamp base 150 includes a plurality of heat dissipating fins 161 and a plurality of fourth fixing parts 162. The plurality of fourth fixing parts 162 are disposed on the connecting base 150. The third fixing part 135 and the fourth fixing parts fix each other. According to the present embodiment, the third fixing part 135 is a hook and the fourth fixing part 162 is a fixing pillar. Each fourth fixing part 162, namely, the fixing pillar, passes through the plurality of heat dissipating fins 161, respectively. The third fixing part 135, namely, the hook, hooks the fourth fixing part 162, namely, the fixing pillar.

According to the present embodiment, each first light-emitting module 13 further includes a first lamp base 137, a first lamp plate 139, and a first lampshade 141. The first lamp base 137 includes a first lamp recess 1371. The first lamp plate 139 is disposed in the first lamp recess 1371 of the first lamp base 137. The first lamp plate 139 includes a plurality of LEDs. Besides, the first lampshade 141 includes a plurality of buckle members 142 on the periphery. The first lamp base 137 includes a plurality of buckle holes 145 corresponding to the plurality of buckle members 143. The plurality of buckle holes 145 are located on the periphery of the first lamp recess 1371. The plurality of buckle members 143 of the first lampshade 141 buckle into the plurality of buckle holes 145 of the first lamp base 137. In addition, the first light-emitting module 13 further includes a first heat dissipating structure 147 disposed on the side of the first lamp base 137 opposite to the first lamp recess 1371.

Moreover, the second light-emitting module 15 further includes a second lamp plate 155 and a second lampshade 157. The connecting lamp base 150 includes a second lamp recess 159. The second lamp plate 155 is disposed in the second lamp recess 159 of the connecting lamp base 150. The second lampshade 157 covers the second lamp plate 155 and is disposed on the connecting lamp base 150. The second lamp plate 155 includes a plurality of LEDs. In addition, the second light-emitting module 15 further includes a second heat dissipating structure 161 disposed on the side of the connecting lamp base 150 opposite to the second lamp recess 159. Furthermore, the second lampshade 157 includes a plurality of buckle members 163 on the periphery. The connecting lamp base 150 includes a plurality of buckle holes 165 corresponding to the plurality of buckle members 163. The plurality of buckle holes 165 are located on the periphery of the second lamp recess 159. The plurality of buckle members 163 of the second lampshade 157 buckle into the plurality of buckle holes 165 of the connecting lamp base 150.

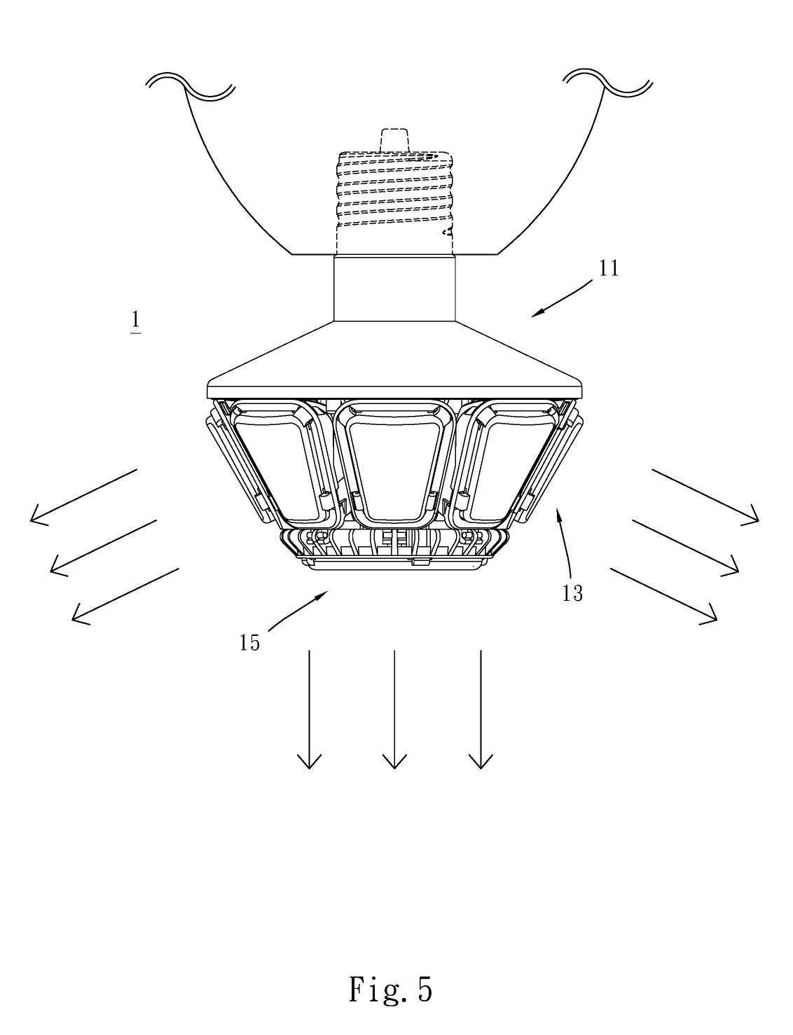

Please refer to FIG. 5, which shows a usage diagram of the lamp structure according to the present invention. As shown in the figure, according to the present embodiment, the lamp structure is disposed on a lamp base. The light-emitting surface of the second light-emitting module 15 is a plane and lighting downwards. The light-emitting surfaces of the plurality of first light-emitting modules 13 are oblique and lighting the surroundings and downwards. The light of the light-emitting surfaces of the plurality of first light-emitting modules 13 can supplement in lighting the ambient of the light from the second light-emitting module 15. Thereby, the light from the lamp structure can be concentrated downwards for lighting.

The present invention improves the drawbacks of the prior art. According to the prior art, the light-emitting surface of an LED lamp structure normally located on the top and side surfaces for forming a light-emitting lamp. In addition, the light from an LED lamp structure is directional. Nonetheless, owing to its directionality, when the lamp structure according to the prior art is disposed on the ceiling, the light from the top light-emitting surface will illuminate downward while the light from the side light-emitting surface will illuminate to the surroundings. Then the light from the lamp structure according to the prior art is not fully utilized in domestic lighting. Accordingly, the present invention provides a lamp structure, which comprises the lamp cap, the plurality of first light-emitting modules, and the second light-emitting module. The second light-emitting module is a planar light source illuminating downwards. The plurality of first light-emitting modules are oblique light sources lighting downwards and to the surroundings. The plurality of first light-emitting modules surround the light-emitting surface of the second light-emitting module. Thereby, the plurality of first light-emitting modules can further supplement the lighting range and intensity of the second light-emitting module.

The overall structure of the lamp structure can be disassembled and assembled with ease. In addition, while maintaining the lamp structure, only the damaged portion should be repaired or replaced, and hence reducing the maintenance cost.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

What is claimed is:

1. A lamp structure, comprising:
a lamp cap, having a body with a connecting surface on the bottom surface;
a plurality of first light-emitting modules, one end of each said plurality of first light-emitting modules surrounding the periphery of said connecting surface; and
a second light-emitting module, having a connecting lamp base, the other end of each of said plurality of first light-emitting modules surrounding the periphery of said connecting lamp base, and the circumference of said connecting lamp base smaller than the circumference of said connecting surface.

2. The lamp structure of claim 1, wherein said connecting surface of said lamp cap further includes a plurality of connecting parts; each of said plurality of connecting parts includes a first fixing part and an electrical connecting part; each of said plurality of first light-emitting modules includes a second fixing part and a second electrical connecting part at one end; said first fixing part and said second fixing part fix each other; and the first electrical connecting part and said second electrical connecting part connect each other.

3. The lamp structure of claim 2, wherein said first fixing part is a fixing recess; said second fixing part is a fixing bump; and said second fixing part is wedged into said first fixing part.

4. The lamp structure of claim 2, wherein each of said plurality of first light-emitting modules includes a third fixing part at the other end; said connecting lamp base includes a plurality of heat dissipating fins and a plurality of fourth fixing parts; said plurality of fourth fixing parts are disposed on said connecting lamp base; and said third fixing part and said fourth fixing part fix each other.

5. The lamp structure of claim 4, wherein said plurality of third fixing parts are hooks; said plurality of fourth fixing parts are fixing pillars; and said third fixing part hooks said fourth fixing part.

6. The lamp structure of claim 1, wherein each of said plurality of first light-emitting modules further includes a first lamp base, a first lamp plate, and a first lampshade; said first lamp base includes a first lamp recess; said first lamp plate is disposed in said first lamp recess of said first lamp base; and said first lampshade covers said first lamp plate and is disposed on said first lamp base.

7. The lamp structure of claim 6, wherein said first lampshade includes a plurality buckle member on the periphery; said first lamp base includes a plurality of buckle holes corresponding to said plurality of buckle members; said plurality of buckle holes are located on the periphery of said first lamp recess; and said plurality of buckle members of said first lampshade buckle to said plurality of buckle holes of said first lamp base.

8. The lamp structure of claim 6, wherein each of said plurality of first light-emitting modules further includes a first heat dissipating structure disposed on the side of said first lamp base opposite to said first lamp recess.

9. The lamp structure of claim 1, wherein said second light-emitting module further includes a second lamp plate and a second lampshade; said connecting lamp base includes a second lamp recess; said second lamp plate is disposed in said second lamp recess of said connecting lamp base; and said second lampshade covers said second lamp plate and is disposed on said connecting lamp base.

10. The lamp structure of claim 9, wherein said second lampshade includes a plurality buckle member on the periphery; said connecting lamp base includes a plurality of buckle holes corresponding to said plurality of buckle members; said plurality of buckle holes are located on the periphery of said second lamp recess; and said plurality of buckle members of said second lampshade buckle to said plurality of buckle holes of said connecting lamp base.
